(19) United States
(12) Patent Application Publication
(10) Pub. No.: US 2008/0047200 A1
(43) Pub. Date: Feb. 28, 2008

(54) Door drive for an automatic door

(75) Inventors: Uwe Krause, Pattensen (DE); Uwe Nolte, Barsinghausen (DE); Guido Sonntag, Gehrden (DE); Heinz Ludwig, Garbsen (DE); Jan Spannberger, Hannover (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/895,930

(22) Filed: Aug. 28, 2007

(30) Foreign Application Priority Data
Aug. 28, 2006 (DE) 10 2006 040 232.4

(51) Int. Cl. E05F 15/20

(52) U.S. Cl. 49/31

(57) ABSTRACT

The invention relates to a door drive for an automatic door having a door panel, a brushless electric motor for generating the drive power and a belt or chain running in the opening and closing direction of the door for transmitting the drive power to the door panel. The door position is affected by a door position controller. An actuation device for controlling and/or regulating the electric motor includes an angle sensor for generating an angular signal proportional to the angle of rotation of the motor and a commutation circuit, for electronically commutating the motor, where the angular signal from the angle sensor is fed. The angular signal is also used as an input variable to the door position controller. The angle sensor is, in particular, an absolute value angle sensor working on a magnetic principle and designed for the unambiguous sensing of one complete revolution of the electric motor.

The invention relates to a door drive for an automatic door, in particular for an automatic sliding and/or lift door which has at least one door panel, with an electric motor for generating the drive power, an actuation device for controlling and/or regulating the electric motor, a belt or chain running in the door's opening and closing direction for transmitting the drive power to the door panel, and with a door position controller.

DE 103 39 621 A1 discloses a brushless electric motor, DE 10 2004 034 636 A1 a direct drive with a rotation angle sensor.

Door drives as cited in the introduction, or similar ones, are known from EP 0 837 536 B1, DE 101 31 211 A1 and DE 20 2005 006 404 U1.

In the field of automatic doors, in particular lift doors, there is a need for the construction of the door drive to be as compact as possible, because the door drive must be mounted so that it is concealed from the user of the lift, so that the installed space for the door drive also affects the compactness and the costs of an entire lift system.

The door drive known from DE 101 31 211 A1 makes available a DC motor with gearbox. Gearboxes produce undesirable noise and transmission losses, and due to the large number of moving mechanical parts lead to rapid wear and costs. Normal DC motors have large and disadvantageous overall dimensions for door controls.

The objective underlying the invention is to construct, in a simple manner but nevertheless cheaply and compactly, a door drive of the type mentioned in the introduction.

In relation to the door drive mentioned in the introduction, this objective is achieved in accordance with the invention by the electric motor having a brushless construction and by the actuation device having
an angle sensor for generating an angular signal proportional to the angle of rotation of the motor and
a commutation circuit, for commutating the electric motor electronically, to which the angular signal from the angle sensor is fed,
   where the angular signal from the angle sensor is fed to the door position controller as an input variable.

The angular signal from the angle sensor is thus used both for the purpose of commutating the motor and also for door position control, which results in particular savings in installation space, effort and costs. Apart from position sensing of the door, the angular signal can also be used to detect the speed of the door.

Preferably, the angle sensor will work on a magnetic principle, will be constructed as an absolute value sensor and designed for sensing unambiguously one complete revolution (3600) of the electric motor.

The use of a combination of a brushless motor with a magnetic absolute value sensor gives a construction which is very compact for door controllers, and quiet operation for a cost which is nevertheless low.

Electronically commutated and/or brushless electric motors are known per se. In the case of an electronically commutated motor, the mechanical commutation system, i.e. the commutator brushes, are replaced by a control unit mounted on the motor, which is referred to as a BL-controller (brushless controller). In this, for example, several high-current silicon chips and a programmable microprocessor undertake the task of the brush-gear, that is of the interaction of the copper segments and the brushes, which are susceptible to wear and interference.

The elimination of the brush system gives the advantage of lower noise generation, the advantage of lower wear and costs, due to the smaller number of moving mechanical parts, together with the advantage of an absence of contamination by abraded matter from the brushes.

A distinction is made between sensorless controllers, described for example in DE 103 46 711 A1, and controllers, which have an angle or rotation sensor for determining the current rotational position of the motor, for example in the form of an optical sensor, a photobarrier, a Hall-sensor in particular a digital Hall-sensor with, for example, 6 distinct states per rotation, a quadrature encoder or a resolver, a special rotary sensor which works on an electrical induction basis and supplies analogue data about the angular setting of the motor, and which is encoded in the form of a sine or cosine amplitude.

For gearless applications, in particular, a very high resolution is required in order to drive a motor using sinusoidal commutation with low noise and cheaply. Until now this has only been possible using a resolver. Resolvers are very expensive and require a great deal of installation space.

Simple Hall sensors and quadrature encoders have the disadvantage that the position of the rotor is not immediately available at any point in time, namely not immediately after the power supply system is switched on. For this reason, a special synchronization process is required for the rotor angle, using a reference point or by means of complex calculations.

For the purpose of commutating a brushless electric motor, the use of a combination of a sensor based on the magneto-resistive effect (AMR sensor) with at least two Hall sensors is known from DE 100 17 061 A1. Using this, the angle can be detected unambiguously over 3600.

In conjunction with the invention, the term absolute value sensor is to be understood as a device which outputs position data in the form of a numerical value—encoded if necessary—which is unambiguous across the entire range of resolution of the absolute value sensor, so that no initial reference or calibration movement, such as is required with an incremental sensor, is necessary.

The absolute value sensor for the door drive takes the form, in particular, of a single-turn sensor.

The magnetic absolute value sensor or rotation angle sensor works, in particular, in accordance with the magneto-resistive or GMR effect. The GMR effect (Giant Magneto-Resistance) is a quantum-mechanical effect which is observed in thin-film structures comprising alternating ferro-magnetic and non-magnetic layers.

The value determination is preferably carried out in a Wheatstone measuring bridge. This can supply a sine/cosine signal in the two half-bridges, from which any position around a full circle (3600) can be identified.

The magnetic absolute value sensor or rotation angle sensor is alternatively made up by connecting together several Hall sensors, preferably 3, 4 or 6 Hall sensors. Intelligent electronic value determination, based for example on DSP, permits unambiguous detection around the entirety of a full circle.

It is further preferred if the angle sensor has a resolution of at least 10 bits/360°, in particular of at least 11 bits/360° or at least 12 bits/360°. This is of particular advantage in conjunction with a slow-rotating motor with a high torque. With a gearless drive, a high temporal resolution is also possible at low rotational speeds. Thus it is even possible to regulate door speeds from very slow to stationary. Furthermore, the high resolution with a gearless drive, and in particular with sinusoidal actuation of the motor, results in almost harmonic-free torque development, which is distinguished by very good smooth-running characteristics with low noise levels.

The use of a magnetic absolute value sensor with a high resolution for actuating the electric motor has substantial advantages for the drive:
a) The rotor position is known at any point in time, that is also directly after the current or voltage supply is switched on, so that there is no longer any need for a synchronization process for the rotor angle.
b) The high angular resolution leads especially to a high temporal resolution, even at low rotational speeds, so that even very slow speeds down to stationary can be regulated.
c) With sinusoidal actuation of the motor there is an almost harmonic-free development of the torque, which is distinguished by very good smooth-running characteristics with low noise levels.
d) Low costs.
e) Small installation height.

To give a compact construction, and in particular for the purpose of accommodating it within a door springer or door lintel, it is particularly expedient if the angle sensor has a length in the axial direction of at most 40 mm, and preferably not more than 20 mm.

In particular, the angle sensor is mounted coaxially with the motor shaft.

The electric motor is preferably designed as a synchronous motor, in particular a permanently-excited one.

The length of the electric motor—measured without any bearings, drive pinion and electronic components which there may be—is preferably less than 60 mm, in particular less than 36 mm.

Apart from this, the length of the electric motor—measured at a distance of at least 35 mm from the shaft and without any bearings, drive pinion and electronic components which there may be—is preferably less than 60 mm, in particular less than 36 mm.

Apart from this it is preferable if the diameter and/or the edge length of the electric motor lies in a range between 50 mm and 200 mm, preferably in the range between 80 mm and 160 mm.

A further expedient arrangement consists in the electric motor having a drive torque of at least 0.008 Nm/kg or of at least 0.01 Nm/kg of door mass, in particular a drive torque in the range from 3.0 Nm to 4.5 Nm, preferably in the range from 3.5 to 4.0 Nm.

In accordance with a preferred form of embodiment, a drive pinion or belt drivewheel to drive the belt or chain, as applicable, is attached to the shaft of the electric motor. This gives, on the one hand, the advantage of a compact construction and, on the other hand, the advantage that the belt or chain, as applicable, can be driven by the electric motor without gearing and/or transmission (direct drive). By comparison with a direct drive, a gearbox would significantly increase the axial length of the complete system comprising the electric motor and gearbox. With a transmission, the installation space would also be increased, because the drive force would have to be initially transferred via the transmission to a dual pinion located outside the axis which, for its part, would only then drive the chain or belt. The lack of gearbox means in addition lower losses and noise generation.

The drive pinion or belt drivewheel is, in particular, attached to an unsupported end of the shaft. This gives the advantage of a universal ability to integrate it into the door system.

It is particularly expedient if the electric motor—preferably in its entirety—is arranged within a door springer or door lintel at the top end of the door, in particular above a lift cage of the lift. In the ideal case, the installation or mounting of the door drive requires no installation space above the lift cage of the lift system. This gives special advantages compared to a solution with a transmission, with which the electric motor must generally be mounted above the door springer.

In conjunction with the invention, a door springer is understood to be any crossbeam which is rigidly built into the door frame, in particular a horizontal profile between the lower door system and an upper part, in the case of a lift the upper part of the lift cage. The door springer is generally arranged to be above the door panel(s) of the door.

In accordance with a quite particularly preferred form of embodiment, the motor is mounted in such a way that its shaft is aligned at right angles to the direction of opening and closing of the door and/or horizontally. This permits an arrangement which is especially compact and, in relation to the drive force, free of linkages and hence low-loss.

A mounting of this type for the electric motor also gives the advantage that the one and same motor, for example one held as a spare part, can be mounted both at the left hand end and at the right hand end on the door springer, or at any required position between them, and hence the distinction between a left and right hand output shaft, required with gearmotors, can be ignored.

In accordance with another preferred form of embodiment, the motor together with its drive pinion or belt drivewheel, as applicable, has a length of less than 100 mm in the direction of the shaft, preferably less than 80 mm. With such dimensions, the motor together with its drive pinion or belt drivewheel, as applicable, can even be accommodated in a door lintel or door springer with particularly small dimensions, with a height and/or width of less than 110 mm.

It is further preferable if the door drive has a controller, with a control program installed, for driving the door to its open and/or closed position.

The controller is made, in particular, in such a way that the electric motor—at least in normal operation—is operated at a speed of less than 600 r.p.m., preferably at a speed of less than 500 r.p.m.

According to a further preferred form of embodiment, the angle sensor is mounted on the side of the electric motor which is screened off from the drive pinion or belt drivewheel.

Overall, it is expedient if the total length of the electric motor, drive pinion or belt drivewheel, as applicable, and angle sensor is less than 110 mm in the direction of the shaft, preferably less than 98 mm.

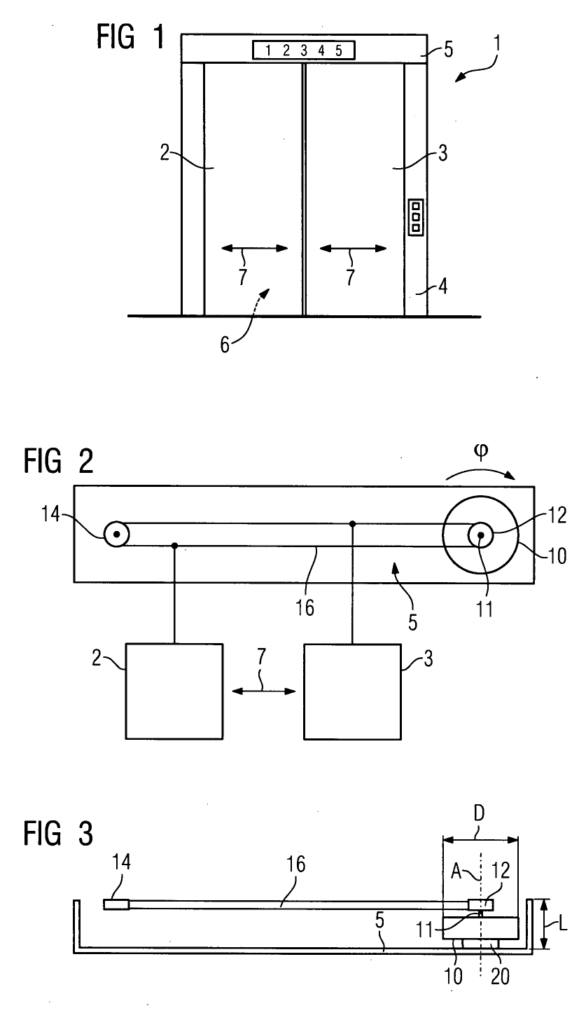

An exemplary embodiment of a door drive in accordance with the invention is explained below in more detail by reference to FIGS. 1 to 5. In the context of this exemplary embodiment, there is also a description relative to door drives of the actuation device and drive device in accordance with the invention, which are to be regarded independently of the special application situation as stand-alone innovative parts. The figures show:

FIG. 1 a door for which a door drive in accordance with the invention can be used,

FIG. 2 a front view of an inner region, a so-called door springer, in the upper part of the door in FIG. 1,

FIG. 3 a plan view of the internals of the door springer in FIG. 2,

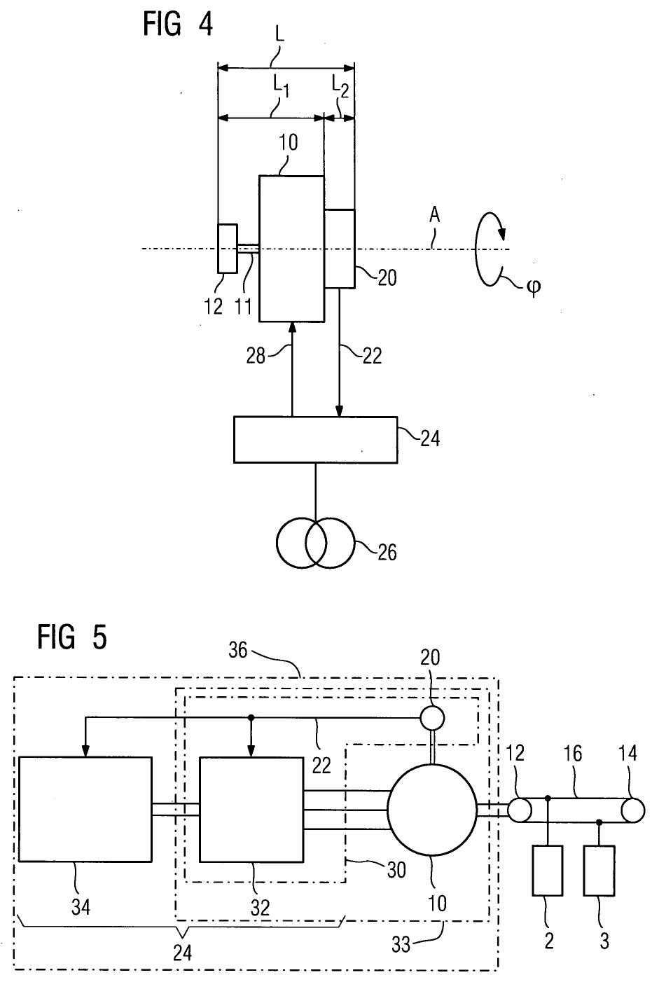

FIG. 4 details of the electrical actuator for the motor used as the door drive in FIG. 1, and

FIG. 5 further details of the use of an angle sensor for the actuation device and the drive device in accordance with the invention.

FIG. 1 shows an automatic door 1 on a lift, with two equal-sized door panels 2, 3 which move in opposite directions. The door 1 is enclosed in a door frame 4, which in its upper region is closed off and supported by a door springer or door lintel 5. When the door panels 2, 3 are open, it is possible to access a lift cage 6 of the lift which is found behind them. The direction of opening and closing of the door panels 2, 3 is indicated by 7. The mass of the doors is up to 400 kg.

FIG. 2 shows a frontal view of the region of the door springer 5, as it would look if the springer cover were taken off, unlike FIG. 1. Within the door springer or door lintel 5, an electronically commutated and brushless, permanently-excited synchronous motor 10 is arranged in such a way that its motor shaft 11 is aligned at right angles to the direction of opening and closing 7, and horizontally, in FIG. 2 at right angles to the plane of the drawing. The motor 10 can have 2-phase or 3-phase actuation. The complete arrangement of electrical commutation and motor 10 can also be referred to as a brushless DC motor.

Fixed to the free end of the shaft 11 is a drive pinion, drive wheel or belt drivewheel 12, or suchlike. Together with an idler pulley 14 mounted at the opposite end of the door springer 5, the belt drivewheel 12 controls a tough toothed belt 16, which transmits the drive force of the motor 10 to the door panels 2, 3.

FIG. 3 shows a plan view of the arrangement in FIG. 2. It is apparent that the motor 10 has a gearless interaction with the toothed belt 16, which is partially made of rubber. The belt drivewheel 12 sits directly on the shaft 11 of the motor 10. The diameter D of the motor 10 is 160 mm.

A digital magnetic absolute value sensor 20 is mounted coaxially with the motor shaft 11, i.e. as shown, on the axis of rotation A of the motor 10. This is explained in more detail in FIG. 4. The depth dimension L of the complete arrangement, consisting of the motor 10, drivewheel 12 and angle sensor 20, is less than or equal to 110 mm. Because of this flat form of construction, the complete arrangement can be accommodated in a door springer 5 or lintel with very compact dimensions.

FIG. 4 shows in detail the complete arrangement consisting of the motor 10, drivewheel 12 and angle sensor 20, and its interaction with a controller 24 assigned to the door drive. Not only is the motor 10 construction especially flat, but so too is that of the angle sensor 20:

Depth dimension L₂ of the angle sensor 20: approx. 30 mm. Depth dimension L₁ of the motor 10 including the drivewheel 12: approx. 80 mm.

Overall depth dimension or overall length L: less than 110 mm.

The angle sensor 20 is located on the side of the motor 10 which is screened off from the drivewheel 12, and is mounted centrally with respect to the axis A of the motor 10. The angle of rotation φ is indicated in the figure. The controller 24 supplies the motor 10 via a line 28 with controlled and regulated power obtained from a power source 26, for example the public electricity supply. The angle sensor 20 reports to the controller 24 a numeric angular value—analogue or encoded—via a line 22. The resolution of the combination of angle sensor 20 and controller 24 is 12 bits, so that for 360° this gives an angular resolution of 360°/4096=0.09°.

FIG. 5 shows in detail in the form of a block diagram how the angular signal 22 from the angle sensor 20 is used simultaneously for different purposes:

a) The controller 24 for the door drive has a commutation circuit 32 for electronic sinusoidal commutation and/or sinusoidal modulation of the motor 10, which takes the form of a synchronous or asynchronous motor. The angular signal 22 is fed to the commutation circuit 32. For this purpose, the high resolution of the angle sensor 20 is required in full measure. This arrangement is especially advantageous with an electronically commutated (EC) and brushless, permanently-excited synchronous motor 10, preferably with no gearbox, because it gives a substantial price advantage for the same functionality by comparison with the rotary resolvers used for commutation. In the case of an EC motor, the commutation circuit 32 can be referred to as a BL controller.

Together with the angle sensor 20, the commutation circuit 32 forms an actuation device 30 in accordance with the invention. Together with the motor 10, the actuation device 30 forms a drive device 33 in accordance with the invention.

b) The controller 24 for the door drive has in addition, as a functional unit, a door position controller 34, to which the angular signal 22 is also fed. The door position controller 34 regulates the door state and/or the door position. From the numeric angular value and the diameter of the drive pinion 12 which is being used, the position of the door panels 2 and 3 is known so that the controller 24 or the door position controller 34, as applicable, can execute operational movements to the open or closed positions or operational movements to determine these extreme positions. This generally requires a lower resolution of the angle sensor 20, and not its full resolution. The door position controller 34 can—for example if a timer is present—also affect, check, control and/or regulate the door speed in addition to the door position.

Together with the door position controller 34, the drive device 33 forms a door drive 36 in accordance with the invention.

1.-23. (canceled)

24. A door drive for an automatic door having a door panel, comprising:
a brushless electric motor that generates drive power;
a belt or chain running in an opening and closing direction of the door that transmits the drive power to the door panel;
a door position controller; and
an actuation device that controls the electric motor, wherein the actuation device has:
an angle sensor for generating an angular signal proportional to the angle of rotation of the motor,
a commutation circuit for commutating the electric motor electronically, to which the angular signal from the angle sensor is fed, wherein the angular signal from the angle sensor is fed to the door position controller as an input variable.

25. The door drive as claimed in claim 24, wherein the angle sensor operates magnetically, is an absolute value sensor and senses unambiguously one complete revolution of the electric motor.

26. The door drive as claimed in claim 25, wherein the motor is a permanently-excited synchronous motor.

27. The door drive as claimed in claim 26, wherein the length of the electric motor without any bearings, drive pinion and/or electronic components is less than 36 mm.

28. The drive device as claimed in claim 27, wherein the length of the electric motor, measured at a distance of at least 35 mm from the shaft and without any bearings, drive pinion and/or electronic components, is less than 36 mm.

29. The door drive as claimed in claim 28, wherein the diameter and/or the edge length of the electric motor is between 80 mm and 160 mm.

30. The door drive as claimed in claim 29, wherein the electric motor is sized and configured to provide a drive torque between 3.5 to 4.0 Nm.

31. The door drive as claimed in claim 30, wherein the angle sensor is based on a GMR effect.

32. The door drive as claimed in claim 31, the angle sensor utilizes a plurality of Hall sensors and is a single-turn sensor.

33. The door drive as claimed in claim 32, wherein the angle sensor has a resolution of at least 12 bits/360°.

34. The door drive as claimed in claim 33, wherein the angle sensor has a length in the axial direction of not more than 20 mm.

35. The door drive as claimed in claim 34, wherein the angle sensor is arranged coaxially with the motor shaft.

36. The door drive as claimed in claim 35, wherein a drive pinion or belt drivewheel that drives the belt or chain is attached to an unsupported end the shaft of the electric motor.

37. The door drive as claimed in claim 36, wherein the belt or chain is driven by the electric motor without gearing and/or transmission.

38. The door drive as claimed in claim 37, wherein the electric motor is arranged completely within a door springer or door lintel at the top end of the door above a lift cage of the elevator.

39. The door drive as claimed in claim 38, wherein the electric motor is mounted such that the shaft is aligned at right angles to the direction of opening and closing of the door and/or horizontally.

40. The door drive as claimed in claim 39, wherein the electric motor together with the drive pinion or belt drivewheel has a length of less than 80 mm in the direction of the shaft.

41. The door drive as claimed of claim 40, further comprising a controller with an installed control program for driving the door to its open and/or closed position.

42. The door drive as claimed in claim 41, wherein the controller is designed such that the electric motor normally operates at a speed of less than 500 r.p.m.

43. The door drive as claimed in claim 42, wherein the overall length of the electric motor, drive pinion or belt drivewheel, and angle sensor is less than 98 mm in the direction of the shaft.
